(19) United States
(12) Patent Application Publication
(10) Pub. No.: US 2026/0254478 A1
(43) Pub. Date: Aug. 27, 2026

(54) METHOD FOR MAINTAINING PHASE COHERENCE OF RF PULSES BY MONITORING AND CORRECTION

(71) Applicant: Q.M Technologies Ltd., Tel Aviv-Yafo (IL)

(72) Inventors: Oded Wertheim, Tel Aviv-Yafo (IL); Yonatan Cohen, Tel Aviv-Yafo (IL); Yuval Toren, Tel Aviv-Yafo (IL)

(21) Appl. No.: 19/548,687

(22) Filed: Feb. 24, 2026

Related U.S. Application Data
(60) Provisional application No. 63/762,824, filed on Feb. 25, 2025.
(60) Provisional application No. 63/819,186, filed on Jun. 6, 2025.

(51) Int. Cl. H04B 1/7075; H04B 1/40; H04L 7/02

(52) U.S. Cl. CPC H04B 1/7075; H04B 1/40; H04L 7/02

(57) ABSTRACT

This disclosure provides a modular control system for quantum systems. The system comprises digital logic configured to generate digital waveform data for multiple channels, multi-channel digital-to-analog converters configured to generate analog outputs, analog front ends connected to the analog outputs, and synchronization circuitry configured to exchange synchronization signals with a peer device. The synchronization circuitry determines phase information according to the synchronization signals and applies phase correction via a baseband signal to a high frequency reference to maintain global timing alignment and phase alignment.

### CROSS REFERENCE TO RELATED APPLICATIONS

This application claims priority to and the benefit of U.S. Provisional Patent Application No. 63/762,824 entitled “A METHOD FOR MAINTAINING PHASE COHERENCE OF RF PULSES BY MONITORING AND CORRECTION” filed Feb. 25, 2025 and U.S. Provisional Patent Application No. 63/819,186 entitled “A METHOD FOR MAINTAINING PHASE COHERENCE OF RF PULSES BY MONITORING AND CORRECTION” filed Jun. 6, 2025. The forementioned applications are hereby incorporated herein by reference in their entirety.

### BACKGROUND

Limitations and disadvantages of traditional interfaces will become apparent to one of skill in the art, through comparison of such approaches with some aspects of the present method and system set forth in the remainder of this disclosure with reference to the drawings.

### BRIEF SUMMARY

Systems and methods herein provide a quantum control interface, substantially as illustrated by and/or described in connection with at least one of the figures, as set forth more completely in the claims.

### BRIEF DESCRIPTION OF THE DRAWINGS

FIG. 1 illustrates an example modular control system comprising channel groups and output connectivity, in accordance with various example implementations of this disclosure.

FIG. 2 illustrates an example synchronization function for maintaining phase coherence and phase persistence for by monitoring phase and applying correction to an upconversion module, in accordance with various example implementations of this disclosure.

### DETAILED DESCRIPTION

The following discussion provides various examples that are non-limiting. The scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Quantum systems require precise electrical control signals to operate reliably. Such control signals may comprise microwave signals and baseband signals that are aligned in time and phase across many channels. As the number of control channels increases, maintaining stability, synchronization, and signal quality becomes more difficult.

Conventional signal generation systems often rely on independent signal paths and calibration processes, which can increase cost and complexity and reduce scalability. There is a need for a modular control system that supports a large number of synchronized channels while maintaining phase alignment, temperature stability, and signal quality.

A control system is disclosed comprising modular circuitry that generates digital waveform data, converts the data to analog outputs, connects the analog outputs to front-end circuitry, and maintains timing and phase alignment across channels. In some embodiments, synchronization circuitry exchanges synchronization signals with a peer device, measures phase according to a synchronization reference, and applies phase correction to a baseband signal generation path. In some embodiments, the system provides selectable digital upconversion for microwave or intermediate-frequency channels and bypass for baseband channels, and supports per-channel delay alignment.

The following description is made with reference to the figures, in which, like reference numerals designate like elements. The embodiments described are examples and are not limiting. Variations in arrangement, partitioning, and implementation can be made while remaining within the scope of the claims.

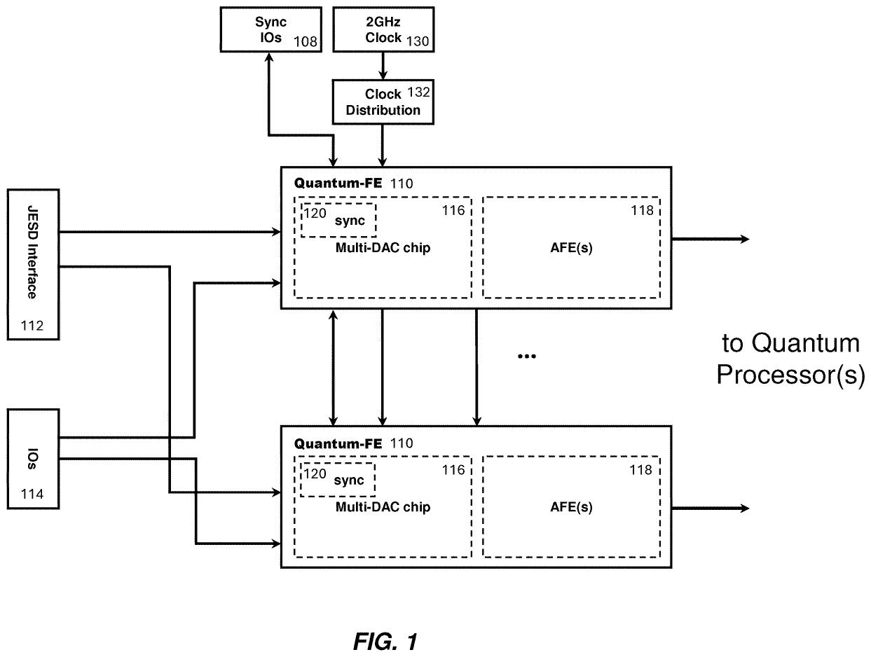

FIG. 1 illustrates an example modular control system comprising channel groups and output connectivity, in accordance with various example implementations of this disclosure.

The control system of FIG. 1 comprises one or more (e.g., 2) quantum frontends (FE) 110. Each quantum FE 110 comprises a plurality of channel groups and provides a plurality of analog outputs for delivering control signals to one or more quantum processors. While the control system of FIG. 1 illustrates 2 multi-outputs devices, any number of outputs may be envisioned. A clock distribution circuitry 132 is configured to distribute a reference clock signal 130 to one or more quantum FEs 110. In some embodiments, the reference clock is approximately 2 GHz

The quantum FEs 110 may be configured to exchange synchronization signals with one or more external/peer devices. A synchronization interface 108 may comprise a sync input and a sync output and may alternatively comprise a bidirectional sync I/O.

A management controller (not shown) may be coupled to one or more interfaces. In some embodiments, the interfaces comprise a host network interface and a management interface. The management controller may perform configuration, calibration management, thermal control, synchronization orchestration, and interface conversion and/or post-processing. Configuration parameters and calibration parameters may be stored in storage.

Temperature sensor(s) and temperature stabilization circuitry (not shown) may be configured to monitor and stabilize temperature associated with signal generation components. Stabilization can improve amplitude stability and phase coherence.

In some embodiments, digital waveform data and control data may be provided using a JESD interface 112 or other I/O 114.

In some embodiments, a quantum FE may be partitioned into a DAC portion 116 and an analog front end (AFE) portion 118. The DAC portion 116 may be configured to comprise one or more converter devices and one or more DAC cores. The analog front end portion 118 may be configured to comprise one or more analog front ends and analog chain components such as amplification and filtering. The partitioning may be used to support replication of channels and modules and may be used to support configuration variation, such as analog front end variation according to selected output requirements.

In some embodiments, synchronization circuitry 120 may be used to maintain timing alignment and phase alignment across channels and may be used to maintain phase alignment across power cycles. The synchronization circuitry 120 may be configured with a high-speed generation circuit comprising a phase-locked loop and may be configured to generate a high-speed signal according to a reference clock.

The synchronization interface 108 may be configured to exchange synchronization signals with the synchronization circuitry 120 using a sync input, a sync output, and/or a bidirectional sync I/O. In some embodiments, a synchronization signal may be a digital pulse train. Other synchronization formats may be used.

The synchronization circuitry 120 may be configured with per-channel buffer and/or digital delay circuitry that may be used to compensate skew between channels. The synchronization circuitry 120 may be configured to measure phase relative to a reference derived from a high-speed generation circuit.

To compensate for the drift in the cable delay, the sync function 302 may perform a phase measurement process similar to two-way time transfer: first, send a pulse from device A to B and measure in device B, then send a pulse from device B to device A and measure in A, thus measuring 2 phases φ_{A→B} and φ_{B→A}. The drift of the phase is measured by B φ_{A→B} as Δφ_{A→B} and the phase is measured by A φ_{B→A} as Δφ_{B→A}. The drift of the clock of device B may now be calculated as (Δφ_{B→A}−Δφ_{A→B})/2 which will be applied to the phase correction 318.

To compensate for the output signal drift, the phase correction 318 may correct the NCO phase in a scale relative to

$$\frac{{f}_{pusle}}{f 1}$$

where fₚᵤₗₛₑ is the central frequency of the transmit pulses and f1 is the frequency used for the phase measurement. As an approximation, the carrier or NCO frequency may be used as the pulse central frequency.

A digital processing chain may be configured with a digital upconversion stage. In some embodiments, the digital upconversion stage may be used for microwave channels and intermediate-frequency channels.

In some embodiments, digital waveform data may be converted to an analog signal using a DAC core within a converter device. A DAC analog output signal may be provided to an analog chain within an analog front end.

The analog chain may be configured with an amplifier, and one or more filters. The analog front end may be varied according to a selected configuration, such as frequency range, output power, and analog filtering.

A method of generating synchronized quantum control signals may be performed by a control system, such as illustrated in FIG. 1.

The processed digital waveform data may be converted to analog outputs using DAC circuitry within one or more converter devices to generate analog signals.

Synchronization signals may be exchanged with one or more peer devices using a sync input, a sync output, and/or a bidirectional sync I/O. The peer devices may be similar Multi-DAC chip devices or dedicated synchronization devices. Phase may be measured using phase measurement circuitry according to a local reference generated by local reference generation circuitry. Phase correction may be computed using phase correction circuitry and may be applied using a baseband phase rotator, DAC NCO phase control, digital delay circuitry, or any combination thereof. The correction may be temperature-tracked according to temperature measurements.

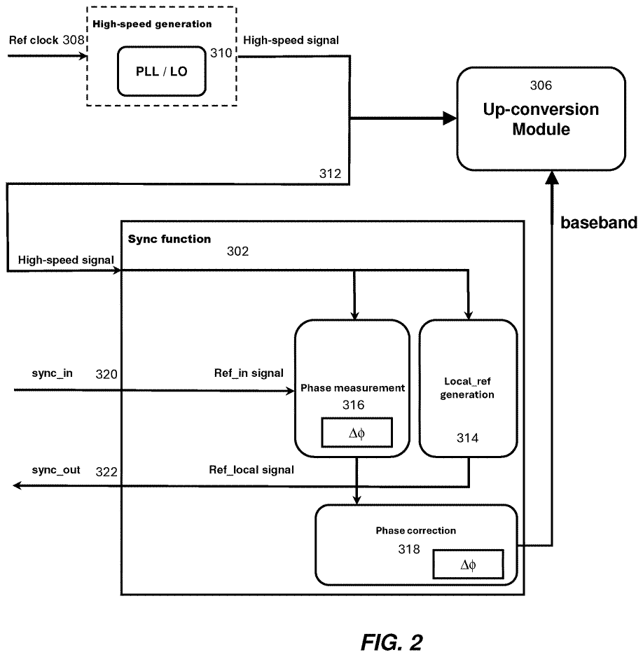

FIG. 2 illustrates an example synchronization function for maintaining phase coherence and phase persistence by monitoring phase and applying correction to an upconversion module, in accordance with various example implementations of this disclosure.

A reference clock 308 is provided to the high-speed generation circuit 310 which produces the high-speed signal 312. The high-speed signal 312 may be used for mixing and/or upconversion via a baseband phase rotator 306.

The synchronization circuitry 302 comprises local reference generation circuitry 314 configured to generate a local reference signal phase coherent with the high-speed signal 312. The synchronization circuitry 302 comprises phase measurement circuitry 316 configured to measure a phase difference (Δφ) between a received synchronization reference and the local reference signal. The synchronization circuitry 302 comprises phase correction circuitry 318 configured to compute a phase correction value (Δφ) according to measured phase values and to apply phase correction to maintain phase coherence and phase persistence. Phase correction may be applied using the baseband phase rotator 306. The baseband phase rotator 306 may be in a peer device. For example, one or more NCOs of the upconversion module 306 may be inside a multi-DAC chip 116 (in FIG. 1). The phase rotation may also adjust the intermediate frequencies in a peer pulse generation module.

In some embodiments, cable delay compensation is performed using peer-device measurements, local measurements, or a combination thereof. In some embodiments, synchronization uses separate sync input 320 and sync output 322. In some embodiments, synchronization may use a bidirectional sync I/O 320/322. A 2-way time transfer measurement may be used to determine a cable delay.

In some embodiments, phase measurement circuitry 316 performs homodyne phase measurement. In some embodiments, phase measurement circuitry 316 performs heterodyne phase measurement. In some embodiments, phase measurement circuitry 316 performs digital sampling of a synchronization reference.

When performing a homodyne measurement, the local ref generator 314 generates a pulse with frequency f₁ in device A and sends it to B, which also generates a pulse at frequency f₁ locally at device B. Device B may then measure both signals by the same analog-to-digital converter or multiply the pulses using a phase detector or mixer and measure the DC offset.

When performing a heterodyne measurement, the local reference generator 314 generates a pulse with frequency f₁+Δf in device A and sends it to B, which generates a pulse at frequency f₁ locally at device B. Device B may then measure both signals by the same analog-to-digital converter or multiply the pulses using a phase detector or mixer, filter, and measure the phase of the Δf signal.

The disclosed system is applicable to quantum computing, quantum sensing, and quantum communication systems requiring precise and scalable control signal generation.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled e.g., by a user-configurable setting, factory trim, etc.). As used herein, the term “based on” means “based at least in part on.” For example, “x based on y” means that “x” is based at least in part on “y” and may also be based on z, for example.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A control system for generating phase-coherent radio-frequency control signals, comprising:
one or more signal-generation modules each comprising a plurality of signal generation channels;
digital logic configured to generate digital waveform data for the plurality of signal generation channels;
one or more multi-channel digital-to-analog converters configured to convert the digital waveform data into a plurality of analog outputs;
analog front-end circuitry coupled to the plurality of analog outputs; and
synchronization circuitry configured to maintain phase coherence across at least a portion of the plurality of signal generation channels,
wherein the synchronization circuitry is configured to:
generate a local reference signal that is phase coherent with a high-speed signal;
measure a phase difference between the synchronization reference signal and the local reference signal over time;
compute a phase correction value based on the measured phase difference; and
digitally apply the phase correction value to a signal generation path selected from a baseband phase rotator, a digital upconversion stage, a numerically controlled oscillator of a digital-to-analog converter, or digitally controlled delay circuitry,
such that phase coherence is maintained despite phase drift occurring during operation.

2. The control system of claim 1, wherein the synchronization circuitry is configured to exchange a synchronization reference signal with at least one peer device.

3. The control system of claim 1, wherein the high-speed signal is generated by a phase-locked loop.

4. The control system of claim 1, wherein the high-speed signal is generated externally from the control system.

5. The control system of claim 1, wherein the phase difference is measured repeatedly during normal signal generation.

6. The control system of claim 1, wherein the phase difference is measured while waveform playback is active.

7. The control system of claim 1, wherein the synchronization reference signal is exchanged using at least one of a synchronization input, a synchronization output, or a bidirectional synchronization input/output.

8. The control system of claim 1, wherein the phase difference is measured using homodyne phase measurement.

9. The control system of claim 1, wherein the phase difference is measured using heterodyne phase measurement.

10. The control system of claim 1, wherein the phase difference is measured by digitally sampling the synchronization reference signal.

11. The control system of claim 1, wherein the phase correction value is applied independently for each signal generation channel.

12. The control system of claim 1, wherein the phase correction value is applied independently for each bonded in-phase and quadrature channel pair.

13. The control system of claim 1, wherein the phase correction value compensates for phase drift caused by at least one of temperature variation, clock variation, or cable delay variation.

14. The control system of claim 13, wherein a cable delay is determined via a bi-directional measurement between the control system and a peer device.

15. The control system of claim 1, wherein the synchronization circuitry comprises per-channel digitally controlled delay circuitry configured to compensate channel-to-channel skew.

16. The control system of claim 1, wherein the synchronization circuitry is configured to maintain phase coherence across multiple signal-generation modules.

17. The control system of claim 16, wherein the multiple signal-generation modules are in separate devices.

18. A method of maintaining phase coherence among a plurality of radio-frequency signal generation channels, comprising:
generating digital waveform data for the plurality of signal generation channels;
converting the digital waveform data into analog signals using one or more multi-channel digital-to-analog converters;
exchanging a synchronization reference signal with at least one peer device;
generating a local reference signal phase coherent with a high-speed signal used for signal generation;
repeatedly measuring a phase difference between the synchronization reference signal and the local reference signal during operation;
computing a phase correction value based on the measured phase difference; and
digitally applying the phase correction value to at least one of a baseband signal path, a digital upconversion stage, a numerically controlled oscillator of a digital-to-analog converter, or digitally controlled delay circuitry, thereby maintaining phase coherence over time in the presence of phase drift.

19. The method of claim 18, wherein the phase difference is measured while waveform playback is active.

20. The method of claim 18, wherein the phase correction value is applied independently for each signal generation channel.

21. The method of claim 18, wherein the phase correction value is applied independently for each bonded in-phase and quadrature channel pair.

22. The method of claim 18, wherein the phase difference is measured using homodyne phase measurement.

23. The method of claim 18, wherein the phase difference is measured using heterodyne phase measurement.

24. The method of claim 18, wherein the phase difference is measured by digitally sampling the synchronization reference signal.

25. The method of claim 18, wherein the phase correction compensates for phase drift caused by at least one of temperature variation, clock variation, or cable delay variation.

26. The method of claim 18, comprising maintaining phase coherence across signal generation channels located in different devices.
